(19) United States
(12) Patent Application Publication
(10) Pub. No.: US 2009/0067593 A1
(43) Pub. Date: Mar. 12, 2009

(54) Method for Dynamically Assembling Voice Messages at a Wireless Communication Device

(75) Inventor: Eskil Gunnar Ahlin, Veberod (SE)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 11/851,853

(22) Filed: Sep. 7, 2007

(51) Int. Cl. H04M 1/64

(52) U.S. Cl. 379/88.22

(57) ABSTRACT

A wireless communication device has a call-answering module that answers incoming calls automatically before alerting a user. The wireless communication device also includes a calendar application that maintains scheduled event information for the user. Upon receiving an incoming call from a remote party, the call-answering module retrieves the scheduled event information from the calendar application to determine the user's status. Based on that scheduled event information, the call-answering module selects one or more prerecorded voice message segments stored in memory of the device, and assembles them to form a complete voice message for transmission to the remote party.

### BACKGROUND

The present invention relates generally to wireless communications devices, and particularly to wireless communication devices having logic that automatically answers incoming calls.

Wireless communication devices such as cell phones may include a variety of call management functionality that allows a user to control incoming calls. Some devices, for example, include a mobile answering machine (MAM) resident in memory. A MAM is a configurable software application that allows the user to selectively reject or reroute incoming calls automatically. For example, before a user attends a meeting, he can configure the MAM to send all incoming voice calls, or selected incoming calls, directly to a voicemail system. The voicemail system may be implemented in the network or locally at the wireless communication device. Once connected to the voicemail system, the remote parties may hear a prerecorded message and leave the user a voice message.

With conventional voicemail systems, remote parties hear generic messages. For example, a “not available” message may tell the remote party that the user is not available to answer calls. However, it does not provide any information as to when the user will be available to return the call, or when the user would be available to receive another call. Without such information, remote parties may tend to repeatedly call the user while the user is unavailable. This could be a nuisance to the calling parties and cause the unnecessary allocation of network resources.

### SUMMARY

According to one embodiment of the present invention, a wireless communication device has a call-answering module configured to answer incoming calls automatically for the user. Before alerting the user, the call-answering module accesses a calendar application executing on the user's device and retrieves scheduled event information for the user. This permits the call-answering module to determine the user's status, such as whether the user is currently in a meeting and when the user will be available to return the call. Based on that information, the call-answering module selects one or more prerecorded voice message segments stored in a memory of the device.

The present invention selects one or more appropriate voice message segments based on the scheduled event information, and assembles them to generate a complete voice message that is rendered to the remote party. The assembled voice message provides the remote party with detailed information, such as the user's status and a time when the user will be available return calls.

### BRIEF DESCRIPTION OF THE DRAWINGS

FIG. 1 is a block diagram illustrating a wireless communication device configured according to one embodiment of the present invention.

FIG. 2 is a flow chart diagram illustrating a method of assembling a voice message at a wireless communication device according to one embodiment of the present invention.

FIG. 3 illustrates one method by which sentence fragments are organized for retrieval by one embodiment of the present invention.

FIG. 4 illustrates a voice message assembled according to one embodiment of the present invention.

### DETAILED DESCRIPTION

The present invention allows a user to dynamically generate custom voice messages at a wireless communication device based on the user's status. The voice messages are rendered to remote parties who call when the user is unavailable to answer the call. In one embodiment, a call-answering module on the user's device has access to a plurality of prerecorded voice message segments, and a calendar application on the device. When the call-answering module answers an incoming call, it obtains the user's current scheduled event information from the calendar application. Based on this information, the call-answering module selects appropriate voice message segments from memory, and assembles them to form a complete voice message to render to the remote party. The assembled voice message may include detailed information about the user's schedule, such as the user's current location, current status, and when the user expects to be available to receive or return calls.

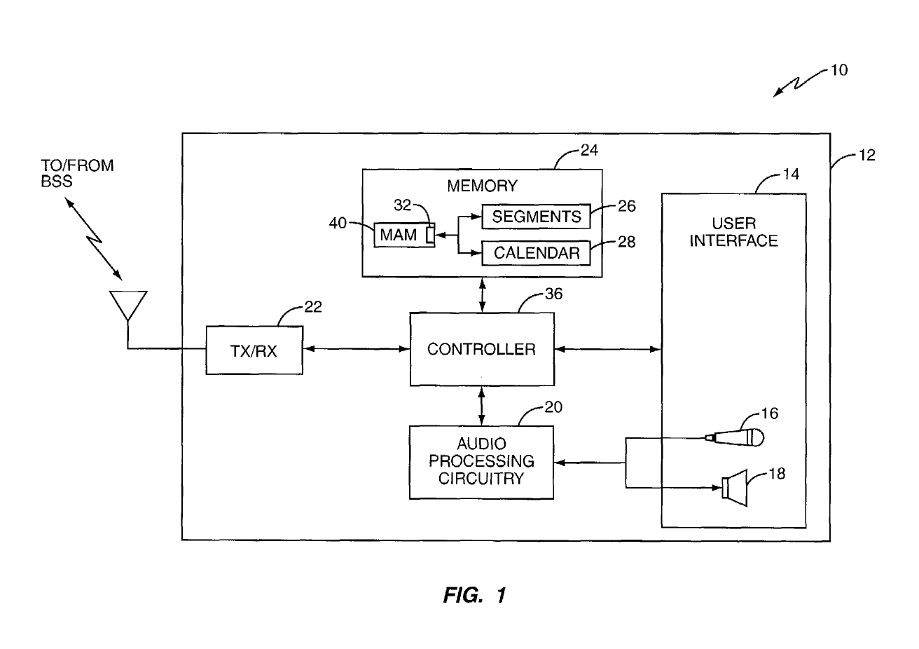

FIG. 1 illustrates a wireless communication device 10 configured to operate according to one embodiment of the present invention. The figures and the specification describe the wireless communication device 10 in terms of a cellular telephone; however, this is for illustrative purposes only. Wireless communication device 10 may comprise any electronic device capable of sending and receiving communications via a communication network. Such devices include, but are not limited to, suitably equipped laptop and notebook computers, satellite phones, Personal Communication System (PCS) terminals, and Personal Digital Assistants (PDAs).

Wireless communication device 10 comprises a housing 12, a user interface 14, audio processing circuitry 20, a transceiver 22, memory 24, and a controller 36. User interface 14 may include devices such as a display, a keypad, a touchpad, a joystick control, control buttons, and other input/output devices, or any combination thereof. The user interface 14 generally allows the user to interact with device 10 to dial numbers, enter commands, scroll through menus, and make menu selections. In one embodiment, the user may enter commands and select parameters used to control a call-answering software module running on device 10 to answer incoming calls automatically based on user-defined preferences.

Microphone 16 receives and converts audible signals, such as the user's detected speech and other audible sounds, into electrical audio signals for use by audio processing circuit 20. Speaker 18 receives analog audio signals from the audio processing circuit 20, and converts them into audible sound that the user can hear. The audio processing circuit 20 processes these audio signals thereby allowing the user to communicate voice traffic with remote parties. In addition, however, the audio processing circuit 20 may also include a speech-recognition system (not shown). Such systems may comprise software and/or circuitry that allow the user to interact with the wireless communication device 10 using his or her voice.

A voice message segment is a part, or all, of a complete sentence. The voice message segments may be words and/or phrases uttered by the user into microphone 16, or may be audio files downloaded from the communication network. Additionally, the voice message segments may be audio files recorded on an external device and transferred to the user's wireless communication device 10. Regardless of how the voice message segments are generated, however, the voice message segments define the basic structure of a complete voice message using words and/or phrases that, standing alone, may not form complete sentences. By way of example, voice message segments may comprise words representing the months of the year (e.g., “January,” February,” etc), or days of the week (e.g., “Monday,” “Tuesday,” etc.), or numbers representing dates (e.g., “first,” “second,” “twenty,” “thirty,” “forty,” etc.). Other voice message segments comprise words representing integers (e.g., “one,” “two,” “five,” etc.), or relate to a time-of-day (e.g., “o'clock,” “noon,” “AM,” “PM”). Still other voice message segments comprise greetings or closings, (e.g., “Hello,” “Goodbye,” “Thanks!”), or phrases that identify a current user status or activity (e.g., “I am in a meeting until . . . ,” “I am on vacation until . . . ,” “ . . . and will return . . . ,” “I will return your call after . . . ,” “Please call me back after . . . ,” etc.).

According to the present invention, the pre-recorded voice message segments are stored in memory 24 under unique filenames. The message segments may be associated with specific events in the user's calendar. A message generator selects desired voice message segments based on the user's activity or status, and assembles them to form a complete voice message that is rendered to the remote party when the user is unavailable to answer the call.

Transceiver 22 and its corresponding antenna allow a user to wirelessly communicate speech and data signals to and from a Base Station Subsystem (BSS) in a wireless communications network. Transceiver 22 may be a fully functional cellular radio transceiver that operates according to any known standard. With the present invention, the transceiver 22 receives incoming calls from remote parties and transmits complete voice messages that have been dynamically assembled by the wireless communication device 10 from one or more selected prerecorded voice message segments.

Memory 24 represents the entire hierarchy of memory in wireless communications device 10, and may include both random access memory (RAM) and read-only memory (ROM), as well as magnetic or optical disk storage. Memory 24 stores programs and data needed by controller 36 to operate the wireless communication device 10. As seen in FIG. 1, these include prerecorded voice message segment 26, a calendar application 28 that maintains the user's scheduled event information, and a mobile answering machine (MAM) 30 that interfaces with the prerecorded voice message segment 26, and with the calendar application 28 via their respective interfaces 32, 34.

Controller 36 controls the operation of wireless communications device 10 according to the programs and data stored in memory 24. The control functions may be implemented in a single microprocessor, or in multiple microprocessors. Suitable processors may include, for example, both general purpose and special purpose microprocessors. As seen in FIG. 1, the controller 36 and the MAM 30 separate components. However, this is not required. In some embodiments, MAM 30 may comprise a card, for example, that includes the software and hardware components necessary to automatically answer incoming calls. In such cases, the controller 36 may be co-located with the MAM 30.

According to the present invention, controller 36 executes according to the instructions and logic of the MAM 30 to answer an incoming call automatically when the user is unavailable, and to dynamically generate a complete voice message from selected voice message segment 26 for transmission to the remote party. The complete voice message may provide the remote party with detailed information about the user's schedule not typically available with the generic voice messages of conventional voicemail systems. By way of example, the assembled voice message may include such information as the user's current location, current status, and when the user expects to be available to receive or return calls.

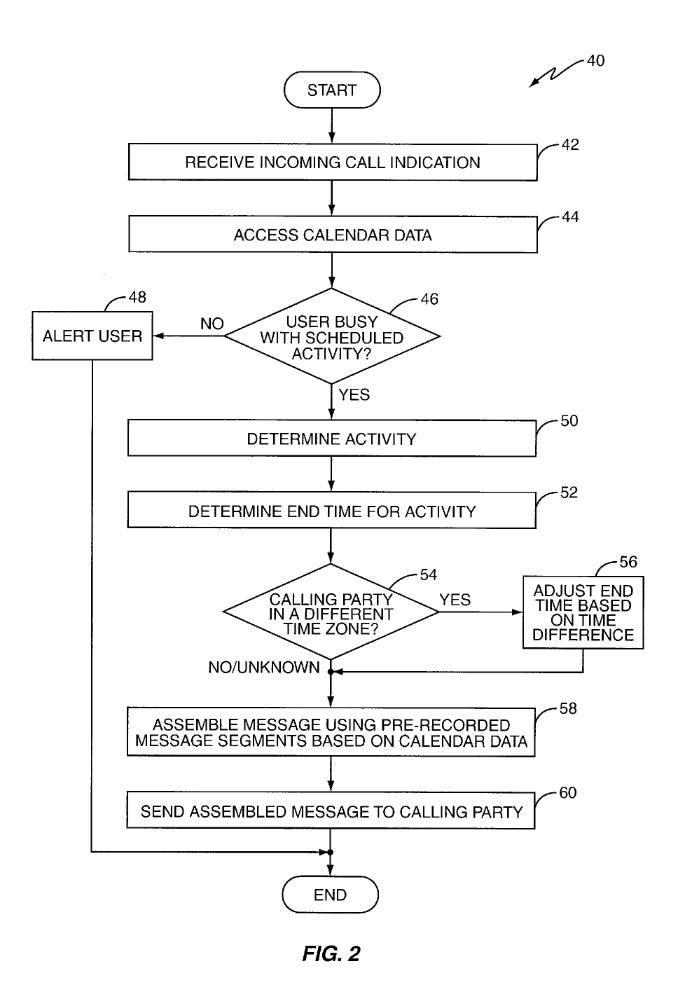

FIG. 2 illustrates a method 40 by which a wireless communication device 10 may assemble a complete voice message to render to a remote party. It is assumed here that the user has already configured the MAM 30 to automatically answer an incoming call.

Method 40 begins when an incoming call indication arrives at the user's device 10 (box 42). Before the MAM 30 generates a ring tone or other alert for the user, the MAM 30 accesses the scheduled event information maintained by the calendar application 28 to obtain the user's current status (box 44). In one embodiment, for example, the calendar application 28 includes an Application Programming Interface (API) to support requests from external applications such as MAM 30 to retrieve scheduled event information. If there are no scheduled events (i.e., the user is currently available to answer the call) (box 46), device 10 generates an appropriate alert for the user (e.g., a ring tone) and the method ends (box 48). If there are scheduled events for the user, however, the MAM 30 retrieves the scheduled event information to determine the specifics of the event, such as the specific activity the user is engaged in (box 50), and a time at which the scheduled activity will end (box 52).

The MAM 30 may also examine the data of the incoming call record to determine other information that could be helpful in generating a customized voice message. In one embodiment, for example, the MAM 30 could examine a country prefix in the incoming call record to determine whether the remote party is in a time zone that is different from the user's current time zone (box 54). If so, controller 36 may adjust the retrieved end time to reflect the remote party's time zone (box 56). The MAM 30 then uses the retrieved scheduled event information and the adjusted end time, if appropriate, to select the voice message segment 26 and assemble the voice message segments into a complete voice message (box 58). The MAM 30 then renders the assembled voice message to the remote party (box 60).

The MAM 30 may not always be able to determine the time zone of the remote party, or may determine that the remote party's time zone is the same as the user's time zone (box 54). In these cases, MAM 30 simply uses the retrieved scheduled event information to select the appropriate voice message segments 26 and assembles them into a complete voice message (box 58) for rendering to the remote party (box 60).

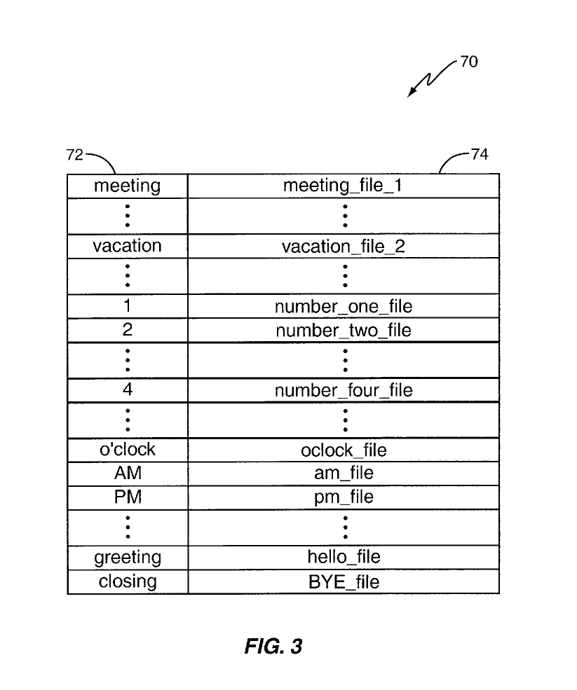

Those skilled in the art will appreciate that the voice message segments 26 may be stored in memory 24 in any manner desired. As seen in FIG. 3, for example, one embodiment of the present invention organizes the voice message segments 26 as entries in a table 70. Each entry comprises an index 72 that matches a keyword or phrase in the scheduled event information, and a filename 74 that is associated with the corresponding prerecorded voice message segment 26. To select a desired voice message segment 26, the MAM 30 compares the keywords retrieved with the scheduled event information with the index 72 and, upon finding a match, retrieves the corresponding filename 74.

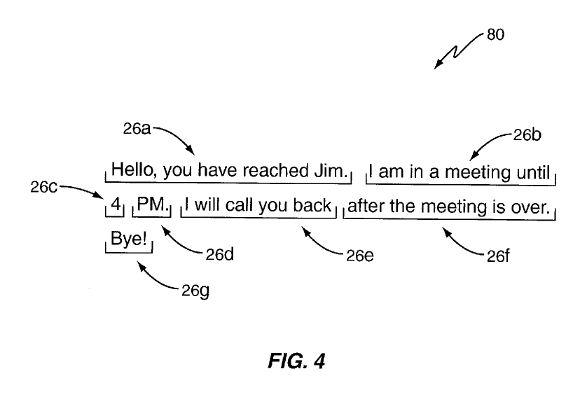

FIG. 4 illustrates a voice message 80 assembled according to method 40. In this example, the scheduled event information reflects that the user is in a meeting until 4:00 p.m., and that the user will return calls after the meeting is over.

As seen in FIG. 4, the assembled voice message 80 comprises a plurality of prerecorded voice message segments 26a-26g. Some segments, such as voice message segments 26a and 26g, represent generic greeting and closing segments selected from table 70. The MAM 30 need not select such generic segments based on scheduled event information obtained from the calendar application 28, but may be configured to begin and end all or selected voice messages with these voice message segments. Voice message segments 26b-26f, however, are selected from table 70 based on the scheduled event information returned by the calendar application 28. In this example, the user is in a scheduled meeting until 4:00 PM, and will return calls after the meeting is over. As previously stated, voice message segments 26c, 26d may be adjusted to reflect the remote party's time zone as desired. Each of the segments 26b-26f are selected based on this information and assembled to form message 80.

The completed voice message 80 may be sent to the remote party using any known method. For example, the MAM 30 may send the filenames 74 of each selected voice message segments 26a-26f to the controller 36 in sequence. In response, the controller 36 may generate one or more control signals to the audio processing circuit 20 to read each audio file. In one embodiment, the audio processing circuit 20 processes the audio signals associated with each identified file to render the audio to the remote party during processing. This method may help to minimize delay, and is beneficial for devices 10 that have limited amounts of memory. In other embodiments, such as where the devices 10 have adequate memory resources, the audio processing circuit 20 first reads each file into a buffer in sequential order. Once all files have been read into the buffer, the audio processing circuit 20 sends the contents to the remote party as a single voice message.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of generating a personal greeting on a wireless communication device, the method comprising:
storing a plurality of prerecorded voice message segments in a memory of a wireless communication device;
retrieving event data stored in the memory responsive to receiving an incoming call from a remote party; and
assembling a voice message from the plurality of prerecorded voice message segments based on the event data.

2. The method of claim 1 wherein each prerecorded voice message segment comprises one or more words stored in memory of the wireless communication device.

3. The method of claim 1β wherein assembling the voice message comprises selecting one or more of the voice message segments based on the event data content, and concatenating the voice message segments to generate the voice message.

4. The method of claim 1 wherein the event data comprises scheduled event information associated with the user, and is maintained by a calendar application executing on the wireless communication device.

5. The method of claim 4 further comprising determining a current status for the user based on the scheduled event information, and assembling the voice message from one or more of the prerecorded voice message segments selected based on the determined status.

6. The method of claim 1 wherein assembling the voice message comprises:
determining a time zone for the remote party based on call information associated with the incoming call;
adjusting a call back time to reflect the time zone of the remote party if the remote party's time zone is different than a time zone of the user; and
selecting at least one of the prerecorded voice message segment based on the adjusted call back time.

7. The method of claim 1 further comprising establishing a communication interface between a call-answering module that automatically answers the incoming call and assembles the voice message, and a calendar application that stores the event data.

8. A wireless communication device comprising:
a memory configured to store scheduled event data maintained by a calendar application executing on the wireless communication device; and
a controller configured to:
retrieve the scheduled event data from the memory responsive to receiving an incoming call; and
assemble a voice message from a plurality of prerecorded voice message segments stored in the memory based on the content of the scheduled event data.

9. The wireless communication device of claim 8 further comprising a transceiver to transmit the assembled voice message to the remote party.

10. The wireless communication device of claim 9 wherein the controller is further configured to:
select one or more of the prerecorded voice message segments based on the scheduled event data; and
concatenate the selected voice message segments to assemble the voice message.

11. The wireless communication device of claim 10 wherein the controller is further configured to determine a current status for the user based on the scheduled event information, and select the one or more prerecorded voice message segments based on the determined status.

12. The wireless communication device of claim 10 wherein the controller is further configured to select at least one of the prerecorded voice message segments based on a difference in time zones between the remote party and the user.

13. The wireless communication device of claim 10 wherein each of the plurality of prerecorded voice message segments comprises one or more uttered words.

14. The wireless communication device of claim 8 further comprising a calendar module executing on the wireless communication device configured to maintain the scheduled event data.

15. A call-answering module for dynamically generating personal greetings at a wireless communication device, the module comprising:
an application interface configured to connect the call-answering module to a calendar application that maintains a user's scheduled event data; and
call-answering logic configured to:
retrieve the scheduled event data via the application interface responsive to receiving an incoming call from a remote party;
select prerecorded voice message segments stored in the memory based on the scheduled event data; and
assemble a voice message from the selected prerecorded voice message segments to render to the remote party.

16. The call-answering module of claim 15 wherein the call-answering logic is further configured to automatically answer the incoming call prior to alerting the user.

17. The call-answering module of claim 15 wherein the call-answering logic is further configured to assemble the voice message by concatenating the selected voice message segments for transmission to the remote party to assemble the voice message.

18. The call-answering module of claim 17 wherein the call-answering logic is further configured to determine a current status for the user based on the scheduled event information, and to select the prerecorded voice message segments based on the determined status.

19. The call-answering module of claim 15 wherein the call-answering logic is further configured to select at least one of the prerecorded voice message segments based on a computed time zone difference between the remote party and the user.
